(19) United States
(12) Patent Application Publication
(10) Pub. No.: US 2022/0058592 A1
(43) Pub. Date: Feb. 24, 2022

(54) MACHINE-READABLE OPTICAL CODES

(71) Applicant: Hewlett-Packard Development Company, L.P., Spring, TX (US)

(72) Inventors: Mohit Gupta, San Diego, CA (US); Jacob Lowman, San Diego, CA (US); Jason Ford, San Diego, CA (US)

(73) Assignee: Hewlett-Packard Development Company, L.P., Spring, TX (US)

(21) Appl. No.: 17/417,574

(22) PCT Filed: May 15, 2019
(86) PCT No.: PCT/US2019/032406

§ 371 Date: Jun. 23, 2021

(51) Int. Cl. G06Q 10/00; G06F 16/38; G06F 16/332

(52) U.S. Cl. CPC G06Q 10/20; G06F 16/3326; G06F 16/381

(57) ABSTRACT

An example computing device can include a processing resource and a memory resource storing instructions thereon, the instructions executable by the processing resource to: extract job information associated with a physical device from a database, compress the job information associated with the physical device; generate a machine-readable optical code that includes the compressed job information associated with the physical device, and update the machine-readable optical code with additional job information associated with the physical device.

### BACKGROUND

Machine-readable optical codes can be visual images that can be a representation of data. For example, a machine-readable optical code can be a one-dimensional or two-dimensional barcode that be a visual representation the can be scanned by a scanner device to reveal information encoded into the machine-readable optical code.

### BRIEF DESCRIPTION OF THE DRAWINGS

FIG. 1 is an example computing device for generating a machine-readable optical code consistent with the present disclosure.

FIG. 2 is an example memory resource for generating a machine-readable optical code consistent with the present disclosure.

FIG. 3 is an example system for generating a machine-readable optical code consistent with the present disclosure.

FIG. 4 is an example method for generating a machine-readable optical code consistent with the present disclosure.

### DETAILED DESCRIPTION

Physical devices can receive maintenance or upgrades to increase performance and/or maintain functionality of the physical devices throughout the device life of the physical devices. In some examples, it can be difficult to maintain maintenance records or upgrade records for individual physical devices. For example, a particular physical device can be owned by multiple users that can each utilize a different organization to perform the maintenance or upgrades on the particular physical device. In this example, a first organization that performs a first job on the particular physical device may not have maintenance records of a second job performed by a second organization. In this example, the first organization may not have information about the second job performed that could be helpful in performing the first job.

The present disclosure relates to systems and devices for generating machine-readable optical codes that can be attached directly to a physical device. In some examples, the machine-readable optical code can include encoded job information that is compressed and/or encrypted job information associated with the physical device. In some examples, the job information can include information of functions performed on the physical device over a period of time. In some examples, the job information that is encoded into the machine-readable optical code can be updated when additional jobs such as maintenance or upgrades are performed on the physical device. In this way, a physical machine-readable optical code can be attached to the physical device such that a different user or organization can scan the machine-readable optical code to display the job information associated with the physical device and utilize the job information to perform additional jobs.

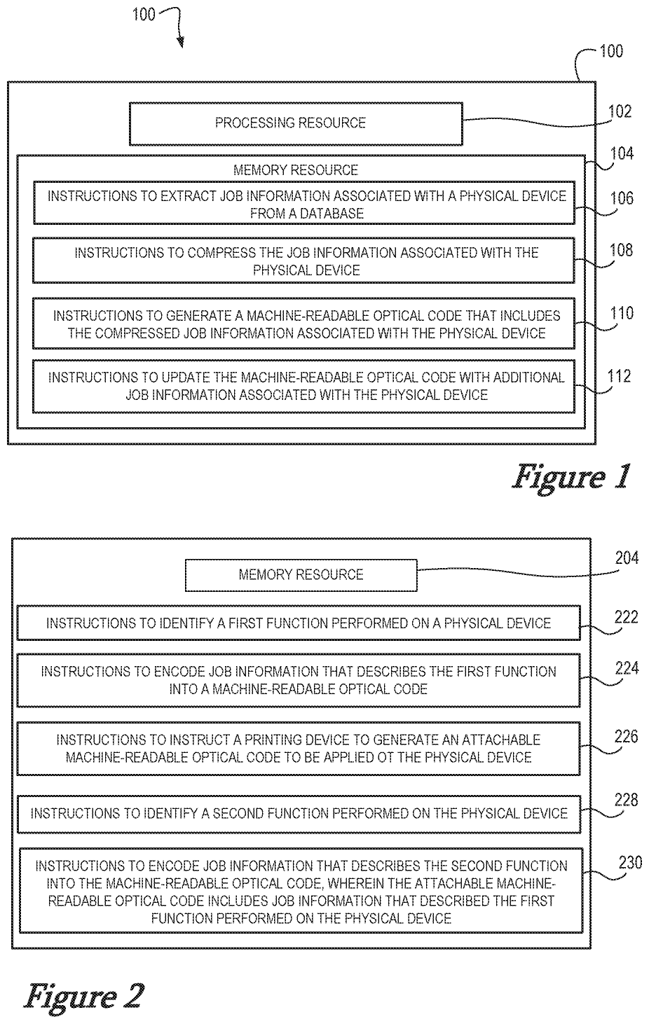

FIG. 1 is an example computing device 100 for generating a machine-readable optical code consistent with the present disclosure. The computing device 100 can include a processing rouser 102 communicatively coupled to a memory resource 104 storing instructions 106, 108, 110, 112 to perform particular functions associated with generating machine-readable optical codes. In some examples, the computing device 100 can be utilized to generate a digital version of the machine-readable optical codes, send the digital version of the machine-readable optical codes to a printing device to be printed as a physical machine-readable optical code, and/or scan the printed physical machine-readable optical codes to retrieve job information encoded into the machine-readable optical code.

Processing resource 102, as used herein, can include a number of processing resources capable of executing instructions stored by a memory resource 104. The instructions 106, 108, 110, 112 (e.g., machine-readable instructions (MRI)) can include instructions stored on the memory resource 104 and executable by the processing resource 102 to implement a desired function (e.g., extract job information associated with a physical device, generate a machine-readable optical code, etc.). The memory resource 104, as used herein, can include a number of memory components capable of storing non-transitory instructions that can be executed by processing resource 102.

The memory resource 104 can be in communication with the processing resource 102 via a communication link (e.g., path). The communication link can be local or remote to an electronic device associated with the processing resource 102. The memory resource 104 includes instructions 106, 108, 110, 112. The memory resource 104 can include more or fewer instructions than illustrated to perform the various functions described herein. In some examples, instructions (e.g., software, firmware, etc.) 106, 108, 110, 112 can be downloaded and stored in memory resource 104 (e.g., MRM) as well as a hard-wired program (e.g., logic), among other possibilities.

Instructions 106, when executed by a processing resource such as processing resource 102 can extract job information associated with a physical device from a database. As used herein, job information associated with a physical device can include information related to actions performed on the physical device. The job information can include information specific to the project or action performed on the physical device, but the job information can also include information related to the project or action performed on the physical device. For example, the related information associated with the job information can include, but is not limited to: date and time the action was performed on the physical device, reasons for performing the action on the physical device, technician performing the action on the physical device, an identification number (e.g., serial number, etc.) of a part utilized, among other information related to the action performed on the physical device.

In some examples, the physical device can be a mechanical device or a part of a mechanical system. For example, the physical device can be a fan or blower of a heating, ventilation, and air conditioning (HVAC) system. In some examples, the physical device can have regular maintenance throughout the lifecycle of the physical device. For example, a physical device may need a part or parts replaced periodically to maintain performance of the physical device. In some examples, the physical device may need repair when a part or parts of the physical device fails. For example, the physical device may malfunction and a service provider can be requested to repair the physical device. In this example, the service provider can examine the physical device and replace a part or parts of the physical device to repair the physical device.

In some examples, a database can be utilized to store information associated with a plurality of physical devices. For examples, the database can be a memory resource that can be utilized to store the job information associated with each of the plurality of physical devices. In some examples, the job information can be uploaded or transferred to the database by technicians that performed jobs on the physical devices. For examples, a technician can perform a job on a physical device. In this example, the technician can upload job information about the job performed on the physical device to the database. In some examples, the information stored in the database related to a particular physical device can be extracted to generate a machine-readable optical code as described further herein.

Instructions 108, when executed by a processing resource such as processing resource 102 can compress the job information associated with the physical device. As used herein, compressing the job information can include reducing the quantity of bits for data storage. For example, a data file representing a portion of the job information can utilize a first quantity of bits to store the data file. In this example, the data file can be compressed to a second quantity of bits. In this example, the second quantity of bits can be less than the first quantity of bits. Different methods or systems for compressing the job information can be utilized. For example, a lossy or lossless compression technique can be utilized to compress the job information associated with the physical device.

As used herein, lossy compression reduces bits by removing unnecessary or relatively less important information from the data file. As used herein, lossless compression includes reducing bits by identifying and eliminating statistical redundancies within the data file. In some examples, the job information can be compressed in order to store a greater quantity of job information within a machine-readable optical code. In this way, a greater quantity of historical job information can be stored within the machine-readable optical code. In some examples, a quantity of bits of the job information associated with a particular physical device can exceed a maximum quantity of bits that is capable of being stored by the machine-readable optical code. In these examples, compressing the job information can reduce the quantity of bits such that the total quantity of bits for the job information can be encoded within the machine-readable optical code.

In some examples, the compressed job information may still exceed the maximum quantity and/or threshold quantity of bits that are capable of being stored by the machine-readable optical code. As used herein, a threshold quantity of bits capable of being stored by the machine-readable optical code can include a set threshold of bits to be utilized when generating the machine-readable optical code. In these examples, a portion of the job information can be removed from the total job information accessible at the time of generating the machine-readable optical code. In some examples, the threshold quantity of bits can be utilized such that a portion of bits can be utilized to update the machine-readable optical code.

In some examples, the portion of the job information that is removed from the total job information accessible can be based on a date associated with the job information. For example, the job information can be organized by a timestamp associated with the job information. In this example, job information with a relatively older timestamp can be removed from the job information prior to generating the machine-readable optical code. In these examples, the relatively older job information may not be as relevant to a current job or action to be performed on the physical device. In some examples, the computing device 100 can utilize a time threshold to determine job information to be removed from the job information to be utilized when generating the machine-readable optical code. In some examples, the time threshold can include a date where job information with timestamps that are older than the date are removed and job information with timestamps that are newer than the date are utilized when generating the machine-readable optical code.

Instructions 110, when executed by a processing resource such as processing resource 102 can generate a machine-readable optical code that includes the compressed job information associated with the physical device. As described herein, the machine-readable optical code can be a one-dimensional, two-dimensional, or other type of machine-readable optical code. In some examples, the job information can be encoded into the machine-readable optical code utilizing a machine-readable optical code generation system. In some examples, scanning the machine-readable optical code can retrieve the job information associated with the physical device. In some examples, the job information retrieved from scanning the machine-readable optical code can be displayed on a user interface. For example, the computing device 100 can be communicatively coupled to a monitor, graphical user interface, and/or display and the computing device 100 can display the retrieved job information on the monitor, graphical user interface, and/or display.

In some examples, generating the machine-readable optical code can include generating a digital machine-readable optical code. As used herein, a digital machine-readable optical code can include a machine-readable optical code that is stored on a memory resource and/or displayed on a monitor coupled to the computing device 100. In some examples, the generated machine-readable optical code can be in a digital format and include the job information that can be extracted by scanning the machine-readable optical code.

In some examples, the digital machine-readable optical code can be sent or provided to a printing device that is communicatively coupled to the computing device 100. As used herein, a printing device can include a physical device that is capable of generating an image on a physical substrate. For examples, the printing device can include a printer that is capable of generating an image on a substrate such as paper, plastic, adhesive substrate, among other types of substrates that can receive a printing substance of the printing device.

In some examples, the printing device can be utilized to generate an attachable machine-readable optical code. As used herein, an attachable machine-readable optical code can include a machine-readable optical code that is displayed on a medium that can be attached to the physical device. For example, the attachable machine-readable optical code can be a sticker with a printed machine-readable optical code on the sticker. As used herein, a sticker can include a printable medium with a first side that includes the machine-readable optical code and a second side that includes an adhesive layer.

In some examples, the printing device can generate the attachable machine-readable optical code in a particular color that represents a feature of a job performed on the physical device. In some examples, the printing device can generate the attachable machine-readable optical code with a color that represents a particular type of job performed on the physical device. For example, a first color can represent a first type of job performed on the physical device and a second color can represent a second type of job performed on the physical device. In another example, the color of the machine-readable optical code can represent a quantity of jobs performed on the physical device. For example, a first color can represent a first quantity range of jobs performed on the physical device (e.g., 1-5 jobs, etc.) and a second color can represent a second quantity range of jobs performed on the physical device (e.g., 6-10 jobs, etc.). In this way, a quantity of jobs or range of the quantity of jobs performed on a physical device can be determined by the color of the machine-readable optical code attached to the physical device.

Instructions 112, when executed by a processing resource such as processing resource 102 can update the machine-readable optical code with additional job information associated with the physical device. In some examples, updating the machine-readable optical code can include generating a different machine-readable optical code to be attached to the physical device. For example, the original machine-readable optical code attached to the physical device can be updated by re-generating a machine-readable optical code that is attachable to the physical device. In this example, the computing device 100 can utilize the same or similar data thresholds to as described herein to generate an updated machine-readable optical code to be attached to the physical device. In some examples, the machine-readable optical code can be updated based on a date a corresponding function or job was performed on the physical device.

In some examples, an existing machine-readable optical code can be updated by encoding additional job information into the existing machine-readable optical code. For example, the computing device 100 can be utilized to encode additional or new job information related to the physical device into the existing machine-readable optical code. In some examples, the computing device 100 can determine when the existing machine-readable optical code can be utilized to encode additional job information into the machine-readable optical code or whether a new machine-readable optical code is to be generated by the computing device 100.

In some examples, features of the machine-readable optical code can be utilized to determine whether the existing machine-readable optical code can be updated or whether a new machine-readable optical code is to be generated by the computing device 100. For example, a color of the machine-readable optical code can be utilized to determine when a new machine-readable optical code is to be generated by the computing device 100. As described herein, a color of the machine-readable optical code can represent a quantity or quantity range of jobs performed on the physical device. Thus, when the quantity of jobs exceeds the quantity or quantity range of jobs performed on the physical device represented by the color of the existing machine-readable optical code, a new machine-readable optical code can be generated with an appropriate color to represent the exceeded quantity or quantity range of the jobs performed on the physical device.

In some examples, a feature of the machine-readable optical code can be a quantity of non-encoded area of the existing machine-readable optical code. For example, the existing machine-readable optical code can include a portion that does not include encoded information. In this example, the portion of the machine-readable optical code may be utilized to encode additional job information. In this example, if additional job information is capable of being encoded into the portion of the machine-readable optical code, the computing device 100 can determine to encode the additional job information into the existing machine-readable optical code instead of generating a new machine-readable optical code. In other examples, the portion of the existing machine-readable optical code that is not encoded may not include enough bits to encode the additional job information. In these examples, the computing device 100 can determine that a new machine-readable optical code is to be generated such that the additional job information can be added to the new machine-readable optical code.

In some examples, the machine-readable optical code can be positioned directly on the physical device such that a user of the physical device and/or a technician performing a job on the physical device can more easily retrieve job information relating to the physical device. In some examples, the machine-readable optical code can be updated or regenerated to include the most recent job information for a particular physical device such that the job information can be utilized to perform a current job on the physical device.

FIG. 2 is an example memory resource 204 for generating a machine-readable optical code consistent with the present disclosure. In some examples, the memory resource 204 can be a computer-readable storage medium as described herein. In some examples, the memory resource 204 can be communicatively coupled to a computing device (e.g., computing device 100 as referenced in FIG. 1, etc.) and/or other type of physical device (e.g. printing device, etc.) that can be utilized to generate machine-readable optical codes.

The memory resource 204 can be in communication with a processing resource (e.g., processing resource 102 as referenced in FIG. 1, etc.) via a communication link (e.g., path). The communication link can be local or remote to an electronic device associated with the processing resource. The memory resource 204 includes instructions 222, 224, 226, 228, 230. The memory resource 204 can include more or fewer instructions than illustrated to perform the various functions described herein. In some examples, instructions (e.g., software, firmware, etc.) 222, 224, 226, 228, 230 can be downloaded and stored in memory resource 204 (e.g., MRM) as well as a hard-wired program (e.g., logic), among other possibilities.

Instructions 222, when executed by a processing resource, can identify a first function performed on a physical device. As used herein, a function can include a job, action, and/or alteration of the physical device. As described herein, the physical device can be utilized to perform a function or be part of a system that performs a function. For example, the physical device can be a fan, pump, computing device, network device, and/or other type of physical device. In some examples, the physical device can have functions performed on the physical device to maintain a functional life of the physical device. For example, the physical device can include a plurality of replaceable parts that can fail. In this example, a function performed on the physical device can include replacing or fixing a part from the plurality of replaceable parts.

In some examples, identifying the first function performed on a physical device can include identifying a first job, action, or maintenance visit from a technician. In some examples, identifying the first function can include identifying whether a first scheduled job or action was performed on the physical device. For example, the physical device may include a maintenance schedule that is suggested by a manufacturer or technician of the physical device. For example, a manufacturer of a car can include a maintenance schedule that suggests the engine oil be changed every five thousand miles. In this example, identifying the first function performed on the physical device can be a first engine oil change performed on the car. In this example, the job information relating to the first job can include a date the oil change was performed, a type of oil used, a filter used, a technician that performed the oil change, among other descriptions of the engine oil change.

Instructions 224, when executed by a processing resource, can encode job information that describes the first function into a machine-readable optical code. In some examples, the job information can include a description of the first function that was performed on the physical device. For example, the job information can include a part or parts that were replaced on the physical device. In other examples, the job information can include related information to the project that was performed on the physical device. In some examples, the related information can be based on an organization performing the project. For example, the first function can be performed under a warranty policy. In this example, the related information can include information that can be provided to for warranty information at a later time.

As used herein, encoding job information into the machine-readable optical code can include generating the machine-readable optical code such that the job information is encoded within the machine-readable optical code. In some examples, encoding the job information can include compressing the job information such that compressed job information is encoded into the machine-readable optical code. In some examples, encoding the job information can include determining a portion of the job information to be encoded within the machine-readable optical code.

As described herein, a portion of the job information can be selected based on priority level of the information and/or a time stamp associated with the information. For example, the first project or job performed can include a corresponding timestamp. In this example, if the timestamp of the first project is relatively older than other projects, the job information related to the first project can be removed such that the job information associated with the other projects is encoded into the machine-readable optical code.

In some examples, encoding job information into the machine-readable optical code can include encrypting the job information such that encrypted job information is encoded into the machine-readable optical code. In some examples, a customer number or unique identifier associated with the physical device can be utilized as part of a key to encrypt the job information. For example, a portion of a customer number can be utilized as a secret key such that a third party would need access to the customer number to access the job information encoded within the machine-readable optical code. In this way, the job information can be relatively more secure from third party access. That is, the memory resource 204 can include instructions to encrypt the job information associated with the physical device and/or include instructions to provide an encryption key to an authenticated device to decrypt the encrypted job information associated with the physical device.

Instructions 226, when executed by a processing resource, can instruct a printing device to generate an attachable machine-readable optical code to be applied to the physical device. As described herein, the memory resource 204 can be communicatively coupled to a computing device that can include peripheral devices such as printing devices. In these examples, the instructions 226 can instruct the printing device communicatively coupled to the computing device to generate an attachable machine-readable optical code.

As used herein, an attachable machine-readable optical code can include a physical medium with a printable surface on a first side and an adhesive surface on a second side. For example, the attachable machine-readable optical code can be a sticker with an adhesive side (e.g., side with semi-permanent or permanent adhesive applied, etc.) that can be attached to a physical device such that a print side with a machine-readable optical code printed on the print side is exposed to allow a scanner device to scan the machine-readable optical code. For example, the attachable machine-readable optical code can be coupled directly to the physical device by contacting the adhesive side to the physical device. In this way, the physical device can have an attached machine-readable optical code coupled directly to a surface of the physical device.

In some examples, the attachable machine-readable optical code can be utilized to store job information corresponding to the physical device that the machine-readable optical code is attached to directly. In other examples, the machine-readable optical code can be attached to one physical device of a physical system that includes a plurality of physical devices. In these examples, the machine-readable optical code can include job information for only the physical device that the machine-readable optical code is attached to directly. In other examples, the machine-readable optical code can include job information for the physical system associated with the device that the machine-readable optical code is attached to directly.

Instructions 228, when executed by a processing resource, can identify a second function performed on the physical device. In some examples, the second function can be a different or separate function than the first function. In some examples, the second function can be the same or similar type of job performed on the physical device at a different time than the first function. For example, the first function can be a first job to replace a replaceable part (e.g., filter, brush, oil, etc.) on a first date and the second function can be a second job to replace the replaceable part on a second date. As described herein, replaceable parts of the physical device may be replaced at particular time intervals to maintain the functionality of the physical device. In this way, the machine-readable optical code can be utilized to store encoded information about the maintenance of replaceable parts and corresponding dates that the replaceable parts were replaced on the physical device. This information can be useful for manufacturers when determining causes of failures. In addition, this information can be useful for warranty providers to ensure that proper maintenance was performed on the physical device during a warranty period. Furthermore, this information can be useful for technicians to better understand a maintenance history of the physical device.

Instructions 230, when executed by a processing resource, can encode job information that describes the second function into the machine-readable optical code, wherein the attachable machine-readable optical code includes job information that describes the first function and the second function performed on the physical device. In some examples, encoding the job information that describes the second function into the machine-readable optical code can include updating the existing machine-readable optical code to include the job information that describes the second function.

As described herein, a machine-readable optical code that is generated to include the job information that describes the first function can include a portion of encodable area that is not utilized. In these examples, the job information that describes the second function can be encoded within the portion of encodable area that was not utilized to encode the job information that describes the first function. In these examples, a new machine-readable optical code may not be generated to encode the job information that describes the second function since the portion of the encodable area that is within the existing machine-readable optical code can be utilized to encode the job information that describes the second function. Thus, in some examples, the machine-readable optical code can be updated with current job information without utilizing a printing device to generate a new machine-readable optical code.

In some examples, encoding the job information that describes the second function can include generating a new attachable machine-readable optical code to replace an existing attachable machine-readable optical code. In some examples, a portion of existing job information can be removed to allow for enough bits to encode the second function. For example, the complete job information that describes the first function and the second function may utilize more bits than are available within the machine-readable optical code even when the job information is compressed as described herein. In this example, a portion of the job information that describes first function and/or the second function can be removed based on features of the information as described herein. For example, the job information can be prioritized based on the features of the information and relatively less important information can be removed to allow relatively more important information to be encoded.

In some examples, the features of the information can include, but are not limited to: a type of information, a date of the job information: a quantity of jobs performed on the physical device, an organization (e.g., manufacturer, warrantor, end user, technician, etc.) that utilizes the information, among other types of information that can be utilized to prioritize the job information. In some examples, the prioritization can be utilized to compress the job information as described herein.

In some examples, the second function can exceed a threshold quantity of functions performed on the physical device. In some examples, the threshold quantity of functions performed on a physical device can be utilized to determine whether a color of the machine-readable optical code should be changed or updated. For example, the machine-readable optical code can include a color that corresponds to a particular quantity or quantity range of functions or jobs performed on the physical device. In some examples, a first machine-readable optical code having a first color can be generated to encode the job information that describes the first function. In these examples, the second function can exceed a threshold quantity of functions for the first color. In these examples, a second machine-readable optical code having a second color can be generated to replace the first machine-readable optical code such that the second color represents the updated quantity of functions or jobs performed on the physical device.

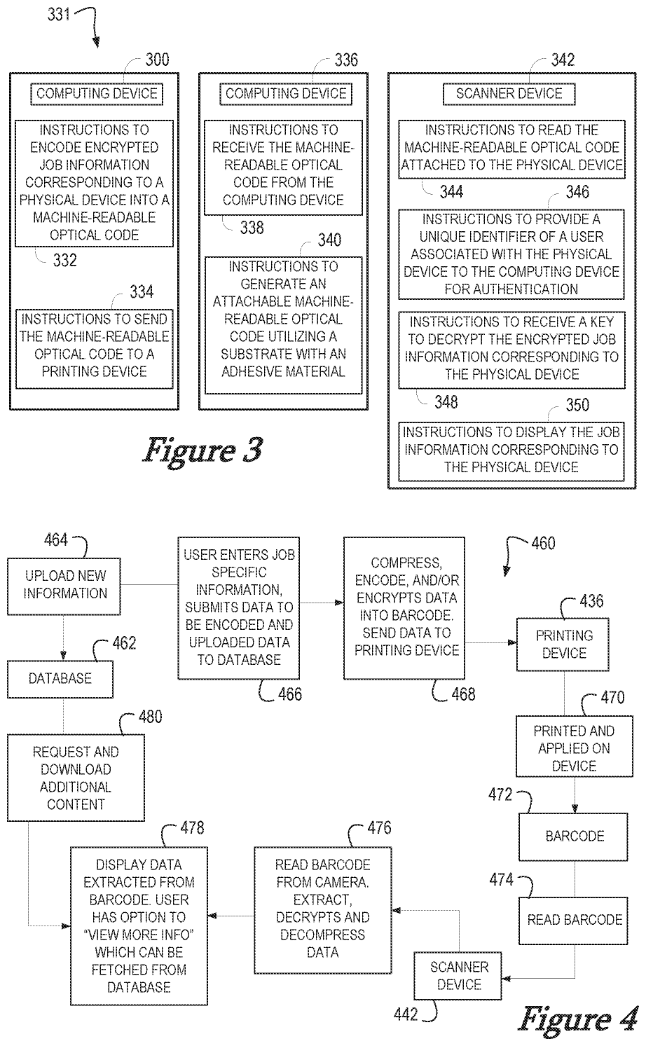

FIG. 3 is an example system 331 for generating a machine-readable optical code consistent with the present disclosure. In some examples, the system 331 can include a computing device 300, a printing device 336, and/or a scanner device 342. In some examples, the system 331 can illustrate separate and individual devices. In other examples, the system 331 can illustrate a plurality of components of a single device. For example, the computing device, printing device 336, and scanner device 342 can be components of a single device for generating, printing, and scanning machine-readable optical codes.

In some examples, the computing device can include a processing resource and memory resource storing instructions 332, 334 that are executable by the processing resource to perform particular functions. Instructions 332, when executed by a processing resource, can encode encrypted job information corresponding to a physical device into a machine-readable optical code. As described herein, the job information can be compressed to save bits when encoding the encrypted job information into the machine-readable optical code.

In some examples, the job information can be encrypted utilizing a unique identifier for the physical device and/or a unique identifier for a customer associated with the physical device. In some examples, the generated machine-readable optical code can include a color that corresponds to a total quantity of jobs performed on the physical device.

Instructions 334, when executed by a processing resource, can send the machine-readable optical code to a printing device 336. As described herein, the printing device 336 can include a device that is capable of depositing a print material (e.g., ink, toner, etc.) on a substrate to generate a physical image such as a machine-readable optical code. In some examples, the computing device 300 can be utilized to generate a digital machine-readable optical code that can be transferred or sent to the printing device 336 to generate a physical machine-readable optical code from the digital machine-readable optical code.

In some examples, the printing device 336 can include a processing resource and memory resource storing instructions 338, 340 that are executable by the processing resource to perform particular functions. Instructions 338, when executed by a processing resource, can receive the machine-readable optical code from the computing device 300. In some examples, the printing device 336 can be communicatively coupled to the computing device 300 such that data packets can be sent between the computing device 300 and the printing device 336. In some examples, data packets that include the digital machine-readable optical code can be sent from the computing device 300 to the printing device 336.

Instructions 340, when executed by a processing resource, can generate an attachable machine-readable optical code utilizing a substrate with an adhesive material. As described herein, an attachable machine-readable optical code can include a substrate that includes a printable side that the printing device 336 can utilize to deposit a print material such as ink to generate the physical machine-readable optical code on the printable side. The attachable machine-readable optical code can include an adhesive or attachable side that is capable of being attached directly to the physical device to display the physical machine-readable optical code on the printable side.

In some examples, the scanner device 342 can include a processing resource and memory resource storing instructions 344, 346, 348, 350 that are executable by the processing resource to perform particular functions. Instructions 344, when executed by a processing resource, can read the machine-readable optical code attached to the physical device. In some examples, the scanner device 342 can include an electronic device that can read and output a machine-readable optical code to a computing device 300. In some examples, the scanner device 342 can utilize a camera device to capture an image of the machine-readable optical code to translate the machine-readable optical code into the encoded job information.

In some examples, the scanner device 342 can utilize a light source, lens, and/or light sensor to translate optical impulses into electrical signals to extract the encoded job information from the machine-readable optical code. In some examples, the scanner device 342 can be a camera device that can capture an image of the machine-readable optical code to provide a digital version of the machine-readable optical code to the computing device 300. In these examples, the computing device 300 can be utilized to extract the encoded job information from the digital version of the machine-readable optical code captured by the scanner device 342.

Instructions 346, when executed by a processing resource, can provide a unique identifier of a user associated with the physical device to the computing device 300 for authentication. As described herein, the job information can be encrypted to prevent unwanted third part users from accessing the job information. In some examples, the user can have a unique identifier such as a customer number or other type of identification number to authenticate the user as an authorized user. In some examples, the unique identifier can be provided to the user when the machine-readable optical code is generated by the computing device 300 and/or printing device 336. In these examples, the unique identifier can be provided to the computing device 300 to authenticate the scanner device 342 and/or user associated with the scanner device 342.

Instructions 348, when executed by a processing resource, can receive a key to decrypt the encrypted job information corresponding to the physical device. In some examples, the computing device 300 can be utilized to authenticate the scanner device 342 and/or user associated with the scanner device 342. When the computing device 300 authenticates the scanner device 342 utilizing the unique identifier, the computing device 300 can provide a key to the scanner device 342. In some example, the key can be an encryption key that can be utilized to encrypt the job information prior to encoding the job information into the machine-readable optical code. In addition, the key can be utilized to decrypt the encrypted job information to extract the job information from the machine-readable optical code.

Instructions 350, when executed by a processing resource, can display the job information corresponding to the physical device. In some examples, the scanner device 342 and/or the system 331 can include a display that is capable of displaying the decoded job information extracted from the machine-readable optical code. In these examples, the job information can be displayed to a user of the scanner device 342 and/or system 331. As described herein, the displayed job information extracted from the machine-readable optical code can be sent to a third party device and/or computing device 300 such that a third party user (e.g., remote user, technician, technical expert, insurance provider, warrantor, etc.).

In some examples, the scanner device 342 and/or system 331 can provide the job information performed on the physical device to a remote user when an authenticated device such as the scanner device 342 scans the attachable machine-readable optical code. For example, the scanner device 342 can send the extracted job information to a remote computing device. In this example, the remote computing device can be a technician computing device that can be utilized by a technician at a remote location. As described herein, a technician can be a technical expert for the physical device.

FIG. 4 is an example method 460 for generating a machine-readable optical code consistent with the present disclosure. In some examples, the method 460 can be performed by a physical device, computing device, and/or system. For example, the method 460 can be performed by a computing device 300, a printing device 336, and/or a scanner device 342 as illustrated in FIG. 3. In some examples, the method 460 can utilize a database 462 that can be utilized to store and retrieve job information associated with a particular physical device. As described herein, the job information can include a description of a function or job performed on the physical device.

In some examples, the method 460 can, at 464, upload new information to the database 462. In some examples, the new information can be new job information that describes a job performed on a physical device. In some examples, a job or information can be considered “new” when the information is not currently stored within the database and/or currently embedded within a machine-readable optical code such as barcode 472. In some examples, the barcode 472 can be a one-dimensional or multi-dimensional machine-readable optical code.

In some examples, the method 460 can, at 466, provide a user interface to allow a user to enter job specific information (e.g., job information, related job information, etc.) to be stored in the database 462 and/or be encoded within a barcode 472. For example, a user interface can include features to allow information relating to functions or jobs performed on the physical device to be described and stored as a data file. In this example, the digital file that is generated can be stored within the database 462 and/or utilized to generate the barcode 472.

In some examples, the method 460 can, at 468, utilize a computing device (e.g., computing device 300 as referenced in FIG. 3, etc.) to compress, encode, and/or encrypt the data that was entered at 466. As described herein, the job information or job information data can be compressed to lower a quantity of bits utilized to store the information within the barcode 472. As described herein, the compressed data can be encrypted with an encryption key that can be accessed using a unique identifier provided to authorized users. Furthermore, the compressed and encrypted data can be encoded to generate a digital machine-readable optical code such as a digital version of barcode 472. In addition, the method 460 can, at 468, send the digital machine-readable optical code to a printing device 436 (e.g., printing device 336 as illustrated in FIG. 3, etc.).

In some examples, the method 460 can include utilizing the printing device 436 to print a physical machine-readable optical code such as barcode 472 and utilize a user to position the physical machine-readable optical code on the physical device at 470. Once the barcode 472 is positioned on a physical device, the method 460 can utilize a scanner device 442 to read the barcode 472 at 474. As described herein, reading the barcode 472 can include extracting the job information encoded within the barcode 472 utilizing the scanner device 442. As described herein, a scanner device 442 can include a camera device to capture an image of the barcode 472 and/or the scanner device 442 can include a light source and a light sensor to translate optical impulses into electrical signals to extract the job information from the barcode 472.

In some examples, the method 460 can, at 476, read the barcode 472 from a camera and extract, decrypt, and/or decompress the data. In some examples, the scanner device 442 can extract the data encoded within the barcode 472. In these examples, the scanner device 442 can decrypt the data encoded within the barcode 472 utilizing an encryption key that was utilized to encrypt the data. In some examples, the scanner device 442 can request the encryption key from a trusted source (e.g., computing device, database 462, etc.) utilizing a unique identifier associated with a user of the device to authenticate the scanner device 442 with the trusted source.

In some examples, the method 460 can, at 478, display the data extracted from the barcode 472. As described herein, the scanner device 442 can include a display such as a graphical user interface that can be utilized to display digital data. In some examples, the display can include additional options that can be selected to perform additional functions. For example, the display can include options to update the job information encoded within the barcode 472 and/or add new job information to be encoded within the barcode 472.

In some examples, the options can include an additional information option. In some examples, the additional information option can be selected at 478 to request and/or download additional content from the database 462 at 480. In some examples, the additional information and/or additional content can correspond to the physical device associated with the job information encoded within the barcode 472. In some examples, the additional information can include information that was removed from being encoded within the barcode 472. For example, the additional information can be relatively older job information that may not be encoded within the barcode 472 due to utilizing more bits than the barcode 472 allows.

In some examples, the additional information can be additional specification or manufacturer information related to the physical device. For example, the additional information can include manuals or information provided by a manufacturer of the physical device. In this way, a user that reads the barcode 472 that is positioned on the physical device can request additional information about the physical device to help with a current job or function being performed on the physical device.

In some examples, the method 460 can be utilized for a plurality of physical devices to provide machine-readable optical codes for each of the plurality of physical devices. The method 460 can be performed to provide customized information that can be encoded within a barcode 472 that can be positioned directly on the physical device. The customized information encoded within the barcode 472 can be more easily accessible by users and/or technicians compared to previous systems and methods.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. Further, as used herein, “a number of” an element and/or feature can refer to any number of such elements and/or features.

What is claimed:

1. A computing device, comprising;
a processing resource; and
a memory resource storing instructions thereon, the instructions executable by the processing resource to:
extract job information associated with a physical device from a database;
compress the job information associated with the physical device;
generate a machine-readable optical code that includes the compressed job information associated with the physical device; and
update the machine-readable optical code with additional job information associated with the physical device.

2. The computing device of claim 1, comprising instructions executable by the processing resource to encrypt the job information associated with the physical device.

3. The computing device of claim 2, comprising instructions executable by the processing resource to provide an encryption key to an authenticated device to decrypt the encrypted job information associated with the physical device.

4. The computing device of claim 1, wherein the job information includes information of functions performed on the physical device over a period of time.

5. The computing device of claim 1, wherein the generated machine-readable optical code is attachable to the physical device.

6. A non-transitory computer-readable storage medium comprising instructions when executed cause a processor of a computing device to:
identify a first function performed on a physical device;
encode job information that describes the first function into a machine-readable optical code;
instruct a printing device to generate an attachable machine-readable optical code to be applied to the physical device;
identify a second function performed on the physical device;
encode job information that describes the second function into the machine-readable optical code, wherein the attachable machine-readable optical code includes job information that describes the first function and the second function performed on the physical device.

7. The non-transitory computer-readable storage medium of claim 6, wherein the job information that describes the first function includes a first date when the first function was performed and the job information that describes the second function includes a second date when the second function was performed.

8. The non-transitory computer-readable storage medium of claim 6, comprising instructions when executed cause a processor of a computing device to update the job information based on a date a corresponding function was performed.

9. The non-transitory computer-readable storage medium of claim 6, wherein the machine-readable optical code is color coded based on a quantity of functions performed on the physical device.

10. The non-transitory computer-readable storage medium of claim 6, wherein the machine-readable optical code is color coded based on a type of function performed on the physical device.

11. The non-transitory computer-readable storage medium of claim 6, comprising instructions when executed cause a processor of a computing device to provide the job information performed on the physical device to a remote user when an authenticated device scans the attachable machine-readable optical code.

12. A system comprising:
a computing device comprising instructions to:
encode encrypted job information corresponding to a physical device into a machine-readable optical code; and
send the machine-readable optical code to a printing device;
the printing device to:
receive the machine-readable optical code from the computing device; and
generate an attachable machine-readable optical code utilizing a substrate with an adhesive material;
a scanner device to:
read the machine-readable optical code attached to the physical device;
provide a unique identifier of a user associated with the physical device to the computing device for authentication;
receive a key to decrypt the encrypted job information corresponding to the physical device; and
display the job information corresponding to the physical device.

13. The system of claim 12, wherein the scanner device transmits the decrypted job information to a remote computing device.

14. The system of claim 12, wherein the scanner device requests additional information related to the physical device from a remote database.

15. The system of claim 12, wherein the computing device updates the attachable machine-readable optical code with current job information without utilizing the printing device.
